(19) United States
(12) Patent Application Publication
(10) Pub. No.: US 2015/0293764 A1
(43) Pub. Date: Oct. 15, 2015

(54) METHOD AND SYSTEM TO COMPOSE AND EXECUTE BUSINESS RULES

(71) Applicant: Omprakash VISVANATHAN, Chennai (IN)

(72) Inventor: Omprakash VISVANATHAN, Chennai (IN)

(21) Appl. No.: 14/683,793

(22) Filed: Apr. 10, 2015

(30) Foreign Application Priority Data
Apr. 10, 2014 (IN) 1880/CHE/2014

(51) Int. Cl. G06F 9/44; G06F 9/45; G06Q 10/10

(52) U.S. Cl. CPC G06F 8/70; G06Q 10/10; G06F 8/41

(57) ABSTRACT

The present disclosure relates to a computer-implemented method. The computer-implemented method includes composing, with a processor, a plurality of business rules, maintaining, with the processor, a rules repository to store the plurality of business rules, executing, with the processor, the plurality of business rules at runtime, and dynamically refreshing, with the processor, one or more packages and one or more classes by utilizing an OSGi framework. The plurality of business rules run on at least one of a communication device, a cloud platform and a data centre. The plurality of business rules implements a plurality of business rules functions. The rules repository is updated dynamically with a change in the plurality of business rules. The executing is performed after dynamically compiling the plurality of business rules in java to java classes having a byte code. The OSGi framework dynamically refreshes changed rules from a java byte code.

This application claims the benefit of Indian Patent Application Ser. No. 1880/CHE/2014 filed Apr. 10, 2014, the entirety of which is herein incorporated by reference.

### TECHNICAL FIELD

The present invention relates to the field of business rules, and in particular, relates to methods and systems for executing the business rules related to enterprise software in a runtime environment.

### BACKGROUND

Business rules are logical constructs for describing operations, definitions, conditions, and/or constraints. The business rules are composed to achieve one or more results. Further, the business rules are intended to assert business structure or to control/influence behavior of a business. Essentially, the business rules are executed (implemented) on a software data object. As a result of execution, the one or more results specified in the business rules are achieved.

Usually, the business rules are encoded directly in a software application. Essentially, a business user (e.g., a policies owner, a business analyst, and the like) is aware of the business rules and responsible for explaining the business rules to a software developer. The software developer encodes the business rules based upon requirement of the business user. However, it may be inconvenient for the business user to rely only on the software developer for composing and/or updating the business rules every time.

Further, the business rules may change any time, for example, due to regulatory changes, competitor moves and the like, and the business user may need to frequently depend on the software developer for updating the existing rules. Additionally, the business rules encoded or updated by the software developer need to be tested and go through a usual IT delivery cycle which may be time consuming.

A business rule composer overcomes these problems. The business rule composer enables the business users to compose and maintain the business rules themselves. For example, the business user will now be in a position to independently update the business rules. The rules composed by the business users may then be stored and processed by the business rule composer. Presently available business rule composer can work on a single technology. Few of the present business rule composer fail to work simultaneously on desktops, cloud and data centers. Further, some of the presently available business rule composer requires user intervention.

In light of the forgoing discussion, there is a need for a method and system that overcomes the above stated disadvantages.

### SUMMARY

In an aspect of the present disclosure, a computer-implemented method is provided. The computer-implemented method includes composing, with a processor, a plurality of business rules, maintaining, with the processor, a rules repository to store the plurality of business rules, executing, with the processor, the plurality of business rules at runtime, and dynamically refreshing, with the processor, one or more packages and one or more classes by utilizing an OSGi framework. The plurality of business rules run on at least one of a communication device, a cloud platform and a data centre. The plurality of business rules implements a plurality of business rules functions. The rules repository is updated dynamically with a change in the plurality of business rules. The executing is performed after dynamically compiling the plurality of business rules in java to java classes having a byte code. The OSGi framework dynamically refreshes changed rules from a java byte code.

In an embodiment of the present disclosure, the computer-implemented method includes providing, with the processor, the plurality of business rules to a plurality of users.

In an embodiment of the present disclosure, the computer-implemented method includes metering, with the processor, usage of the plurality of business rules by a plurality of users.

In an embodiment of the present disclosure, the computer-implemented method includes charging, with the processor, an amount from the plurality of users based on the usage of the plurality of business rules by the plurality of users.

In an embodiment of the present disclosure, the computer-implemented method includes accepting, with the processor, input in one or more formats. The one or more formats includes at least one of a java bean, a name-value pair, an XML format, a triplet, an OWL/RDF ontologies and objects via bindings.

In an embodiment of the present disclosure, the computer-implemented method includes utilizing, with the processor, asynchronously processing to record a usage of the plurality of business rules by each of a plurality of users.

In an embodiment of the present disclosure, the computer-implemented method includes providing, with the processor, a dynamic runtime view and a wizard runtime view for running the plurality of business rules.

In another aspect of the present disclosure, a computer program product including a non-transitory computer readable medium storing a computer readable program is provided. The computer readable program when executed on a computer causes the computer to perform steps including composing, with a processor, a plurality of business rules, maintaining, with the processor, a rules repository to store the plurality of business rules, executing, with the processor, the a plurality of business rules at runtime and dynamically refreshing one or more packages and one or more classes by utilizing an OSGi framework. The plurality of business rules are configured to run on at least one of a communication device, a cloud platform and a data centre. The plurality of business rules implements a plurality of business rules functions. The rules repository is updated dynamically with a change in the plurality of business rules. The executing is performed after dynamically compiling the plurality of business rules in java to java classes having a byte code. The OSGi framework dynamically refreshes changed rules from a java byte code.

In an embodiment of the present disclosure, the computer readable program when executed on the computer causes the computer to perform a further step of metering a usage of the plurality of business rules by a plurality of users.

In an embodiment of the present disclosure, the computer readable program when executed on the computer causes the computer to perform a further step of charging an amount from the plurality of users based on the usage of the plurality of business rules by the plurality of users.

In an embodiment of the present disclosure, the computer readable program when executed on the computer causes the computer to perform a further step of accepting input in one or more formats. The one or more formats includes at least one of a java bean, a name-value pair, an XML format, a triplet, an OWL/RDF ontologies and objects via bindings.

In an embodiment of the present disclosure, the computer readable program when executed on the computer causes the computer to perform a further step of utilizing, asynchronously processing to record a usage of the plurality of business rules by each of a plurality of users.

In yet another aspect of the present disclosure, a business rules management system is provided. The business rules management system includes a rule composer and a rule manager. The rule composer provides a plurality of editors. The plurality of editors includes an advanced rules editor, a plurality of custom layout editors, a binding editor, an advanced beans editor, a factstore template editor and a result layout editor. The rule manager dynamically compiles business rules in java to java classes having a byte code by using a java compiler API.

In an embodiment of the present disclosure, the advanced rules editor allows a plurality of users to perform a plurality of functions. The plurality of functions includes providing input to add a rule set category, giving description to the plurality of business rules and the plurality of business rules text, and automatically assigning a unique rule id to each of the plurality of business rules.

In an embodiment of the present disclosure, the plurality of custom layout editors being configured for an each bean field type stored in a database.

In an embodiment of the present disclosure, the binding editor sets values for each binding. The set values being retrieved at runtime during execution of the plurality of business rules.

In an embodiment of the present disclosure, the advanced beans editor allows a plurality of users to use a GUI to configure and add a bean.

In an embodiment of the present disclosure, the factstore template editor creates a template for a factstore class, load the factstore class, set their values and run the plurality of business rules.

In an embodiment of the present disclosure, the result layout editor configures a layout for a result screen, allows a plurality of users to assign a tabbed layout for a result pane with different query results displayed in different tabs.

In an embodiment of the present disclosure, the business rules management system includes a database, in a processor, for storing a rules repository, beans, a bean field type, values set by the binding editor and configured layout.

### BRIEF DESCRIPTION OF THE FIGURES

Having thus described the invention in general terms, reference will now be made to the accompanying drawings, which are not necessarily drawn to scale, and wherein:

FIG. 1 illustrates a system for showing an interaction of a business rules management system with a communication device, a cloud platform and a data centre, in accordance with various embodiments of the present disclosure;

FIG. 2 illustrates a system for showing an interaction between an application server and the business rules management system, in accordance with various embodiments of the present disclosure;

FIG. 3 illustrates a block diagram of a communication device, in accordance with various embodiments of the present disclosure; and

FIG. 4 is a flowchart for composing and executing a plurality of business rules, in accordance with various embodiments of the present disclosure.

### DETAILED DESCRIPTION

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

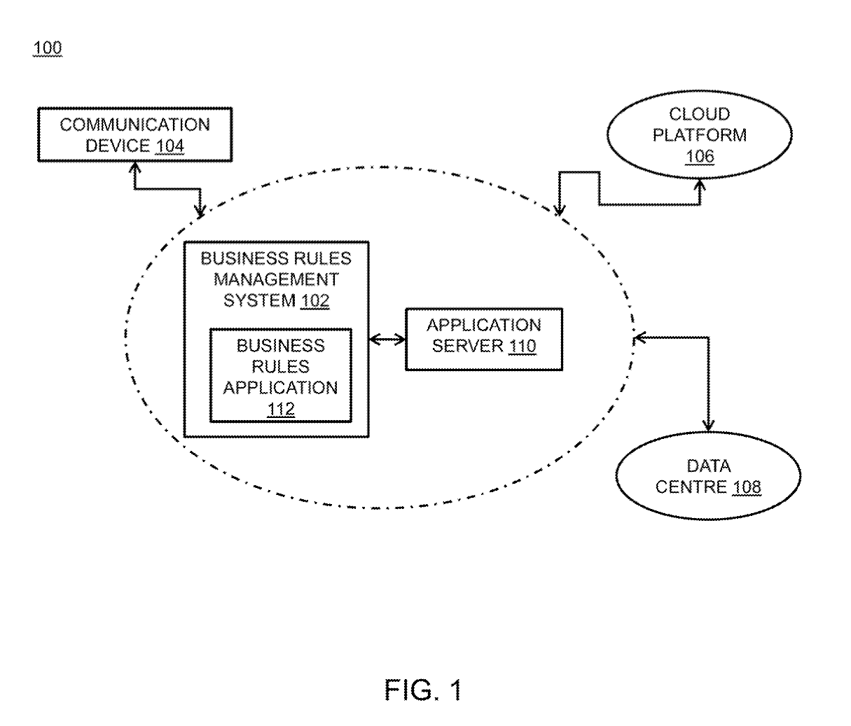

FIG. 1 illustrates a system 100 for showing an interaction of a business rules management system 102 with a communication device 104, a cloud platform 106 and a data centre 108, in accordance with various embodiments of the present disclosure. The business rules management system (hereinafter BRMS') 102 is a system for composing and managing business rules. The BRMS 102 composes the business rules and allows individuals and/or users to use its business rules functions. The BRMS 102 is linked to an application server 110. Further, the BRMS 102 hosts a business rules application 112 and the application server 110 executes the business rules application 112. The business rules application 112 is available for usage and can be run on the communication device 104, the cloud platform 106 and the data centre 108.

Further, the BRMS 102 is a business model based on a pay-per-use or pay-per-transaction model. The BRMS 102 meters usage of the business rules application 112 and charges a plurality of users based on its usage. A primary unit for usage is Queries per Month parameter. The Queries per Month parameter allows the plurality of users to purchase a subscription plan for using the business rules application 112. In an embodiment of the present disclosure, an edition of the business rules application 112 available to each of the plurality of users in a Software-as-a-service model is SaaS. In this Model, each of the plurality of users creates accounts in hosted software and uses its business rules functions. The software itself runs well in the SaaS model.

The business rules application 112 is a rich internet application that uses Ajax together with a web framework to deliver a highly responsive user interface for editing and running the business rules. The business rules application 112 provides a build-in bean generator that generates Java Bean classes from XML. The business rules application 112 can be run on the communication device 104 associated with the user. The communication device 104 may include but not be limited to mobile phones, desktops, tablets and the like. In addition, the business rules application 112 is cloud enabled. The business rules application 112 can run as an independent platform without relying on other services or can run only on the business rules management software 102 utilizing one or more services provided by the cloud platform 106. The one or more services include caching, relational database, message queueing, monitoring, scheduler and the like. Furthermore, the user connects his onsite data center 108 to the cloud platform 106 by using a VPN to further extend the deployment. In an embodiment, the business rules application 112 also runs on a private or a hybrid cloud.

Further, the business rules application 112 can be run in a hosted SaaS mode or in a standalone mode. In the standalone mode, the user can deploy the business rules application 112 to their own cloud server as a private instance. Further, the business rules application 112 provides al-button-connect facility where the business rules application 112 can be installed to a newly provisioned bare bones cloud server in an instant using the business rules application 112 provisioning script. The provisioning script installs and configures the business rules application 112 along with its services.

In an embodiment of the present disclosure, the business rules application 112 can work with any Ajax web framework. The Ajax web framework includes Struts, Struts2, GWT, SmartGWT, Vaadin, Echo2, Echo3, Zk, JSF and its related frameworks like PrimeFaces, ICEFaces, RichFaces and the like. In an embodiment of the present disclosure, GUI front end of the business rules application 112 supports themes and skins. The business rules application 112 provides a built-in set of the themes and the skins that can be further extended using custom themes and skins developed by using CSS, SASS, HTML and the like.

In an embodiment of the present disclosure, the business rules application 112 provides its own built in security architecture that can be augmented by using an oAuth, a Single-Sign-on, an active Directory, a two-factor authentication, a biometric authentication and the like.

It may be noted that in FIG. 1, the business rules application 112 is run on the communication device 104; however those skilled in the art would appreciate that the business rules application 112 may be run on more communication devices.

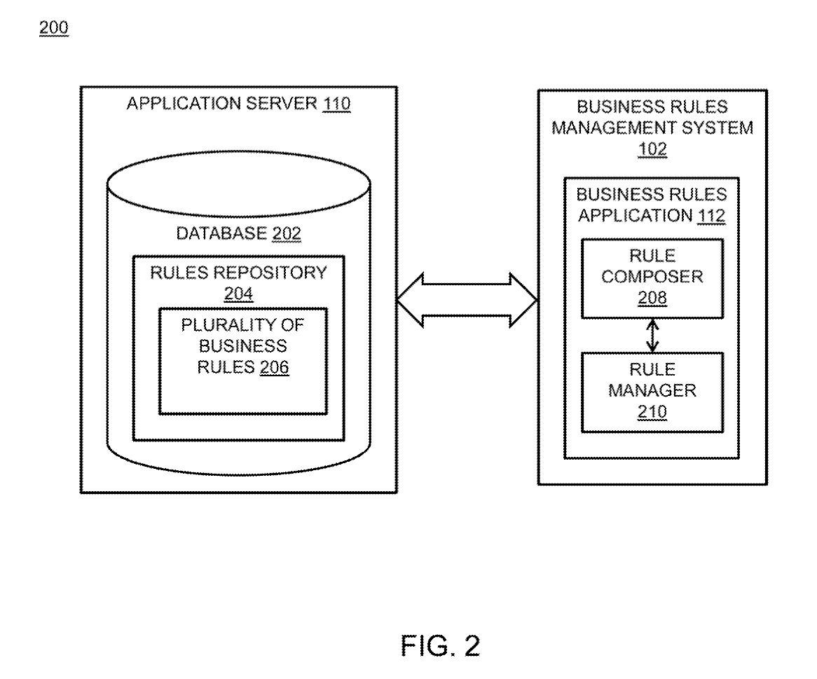

FIG. 2 illustrates a system 200 showing an interaction between an application server 110 and the BRMS 102, in accordance with various embodiments of the present disclosure. The application server 110 includes a database 202. The database 202 stores a rules repository 204. Further, the rules repository 204 stores a plurality of business rules 206. The business rules application 112 of the BRMS 102 includes a rule composer 208 and a rule manager 210. The rule composer 208 provides a plurality of editors. The plurality of editors includes an advanced rules editor, a plurality of custom layout editors, a binding editor, an advanced beans editor, a factstore template editor and a result layout editor. The advanced rules editor inside the business rules application 112 allows the users to input to add a rule set category, description to the plurality of business rules 206, the plurality of business rules 206 text and automatically assigns a unique rule id to each business rule. The advanced rules editor allows editing of any number of rules as it supports pagination.

In an embodiment of the present disclosure, the business rules application 112 allows an automation of workflow stages. Further, there is no need for the plurality of users to intervene in between. The business rules application 112 dynamically executes the plurality of business rules 206 using one or more runtime views. Further, the rule composer 208 provides a plurality of custom layout editors. In addition, the rule composer 208 lets each of the plurality of custom layout editors to be configured for each bean field type which gets stored in the database 202 and can be used at runtime. In an embodiment of the present disclosure, over seventeen different types of plurality of custom layout editors are available.

In addition, the rule composer 208 provides a binding editor. Bindings can be primitive or java bean user defined types. Moreover, each component of each of the plurality of custom layout editors can be configured for each binding. The Binding editor sets values for each binding and stores the values in the database 202. The values are retrieved at runtime when the plurality of business rules 206 are executed. The values for user defined types are saved as blobs. Furthermore, the rule composer 208 provides an advanced beans editor. The advanced beans editor where the plurality of users can use a GUI to configure and add a bean. To add the beam, the plurality of users defines a bean name and adds bean fields to bean settings. For example, annotations, equals method and the like can be added to the bean settings using the GUI. The beans are persistence entities. Java Beans contains java annotations, spring, hibernate, contexts and dependency injections (CDI) and other annotations, for example, ID, entity, table, column, OneToMany and the like. These annotations are useful to persist the beans to the database 202.

In addition, the rule composer 208 provides a factstore template editor. The factstore Template editor creates a template for a factstore class. A Generate Factstore workflow uses the generated factstore template to generate the factstore class at runtime. The rule composer 208 at runtime loads the bindings and factstores, sets their values and then run plurality of business rules 206. The rule manager 210 organizes projects and the plurality of business rules 206. In an embodiment of the present disclosure, the plurality of users has multiple projects and each project may contain multiple rules files. Out of the multiple rules files, only one rule file may be active at any instant of time. Further, the rule manager 210 is responsible for execution of the plurality of business rules 206. A key step in the rules execution process is a Generate Client stage that comes after the Generate Interface. In an embodiment of the present disclosure, a client generator generates a client java program on a fly based on the project and the plurality of business rules 206 settings. In another embodiment of the present disclosure, the client generator generates client java program based on a Velocity template supplied as input and has wrapper methods for each query defined in a business rules file. The client java program acts as an entry point to the rules execution. Moreover, the client java program is dynamically loaded at runtime via reflection and wrapper methods called using the one or more runtime views.

In addition, the rule manager 210 dynamically compiles the plurality of business rules 206 in java to java classes containing byte code by using a java compiler API. Generally, the java classes once loaded in memory cannot be refreshed. However, in an embodiment of the present disclosure, using the OSGi framework, the packages and the classes can be easily refreshed. In another embodiment of the present disclosure, a GroovyScriptEngine dynamically refreshes the classes and the packages. The GroovyScriptEngine directly run a java program as a script without generating classes. Further, the GroovyScriptEngine generates a Groovy code in place of a java code and runs the code directly. In an embodiment, the Hosted business rules application 112 can host the plurality of users directly via a browser or the user can attach a terminal remotely and connect to the one or more services by using a REST API, or the business rules application 112 can authenticate plurality of users by using OpenId, OAuth, OAuth2 and the like and host the plurality of users connecting from other locations, for example, the communication device 104, the cloud platform 106 and the like.

Further, the business rules application 112 of the BRMS 102 enables web scale computing. In an embodiment of the present disclosure, the business rules application 112 platform handles the plurality of users in web scale or upwards of 500 thousand to 3 million concurrent users and hundreds of millions of user accounts. The business rules application 112 platform uses various software including NoSQL databases, caching frameworks, Clustering and load balancing and the like to handle the plurality of users in web scale. The business rules application 112 can run multiple types of plurality of business rules 206 and processes. Further, the business rules application 112 runs simple an if-then type rules projects, factstore projects, inferencing projects and the like. Further, the inferencing projects can be of different types including CLIPS rules, Jena Rules, OWL Ontologies, Soar rules, Drools rules, Jess rules and the like. In an embodiment, the business rules application 112 can run rules from other rules engine vendors including BizSpark, Fico and the like by using adapters.

Further, the business rules application 112 provides a robust platform for delivering all types of applications and not just plurality of business rules 206. Thus, the business rules application 112 is a Generalized Application Delivery Platform (hereinafter ‘GADP’). Moreover, the business rules application 112can accept input in any format java Beans, Name-Value pairs, XML, Triplet, OWL/RDF Ontologies or even objects via bindings. Further, the GADP features include Input/Output, Bean Generator, the Layout Editor, a customizable rules editor, the bindings editor for simple/user defined types, multiple runtime views, themes, user management and the like.

In an embodiment, the business rules application 112 includes an enterprise. The enterprise features include scheduler, caching, security framework, Message Queues, JMX monitoring, chat messaging, cloud connectivity, NoSQL/Relational datastore, Workgroups and the like.

As described in detailed description of FIG. 1, the business rules application 112 can be run on the communication device 104. The business rules application 112 running on the communication device 104 provides same features as the business rules application 112 running on a browser. Further, in an embodiment, some more features can be added to the business rules application 112 running on the communication device 104. Further, the business rules application 112 running on the communication device 104 provides XML editing capability including loading and saving of XML and related formats, Parsing, validating, transformations via XSL style sheets, conversions to other formats, XML pipelines and other features available in XML editors.

In an embodiment, the business rules application 112 running on the communication device 104 is strong in area of XML binding. The XML Binding can work with many binding technologies including JAXB, Schema2Beans, XMLBeans and the like. The business rules application 112 running on the communication device 104 adds value by annotation of the Java Beans to the database 202. This facility is useful in a forefront and emerging area including predictive analytics. In an embodiment, the business rules application 112 is an amalgam of two technologies. The two technologies include XML and the plurality of business rules 206. The business rules application 112 is useful where both XML validations and plurality of business rules 206 validations are required, for example, in Financial Reporting tools including GAAP, XBRL and the like. Further, the business rules application 112 provides a mechanism to render a JavaBean on screen using the Editors and Layout Style configured by using the Layout Editor. This mechanism is referred to as Component Painter. Thus, the business rules application 112 separates concerns of drawing the Java Bean to a screen from configuration. The Java Bean can be rendered wherever it is needed and provide values for viewing the bean fields and the data.

Further, in business rules application 112, the component painter implementation is available as an independent library in places including View Beans Layout screen, runtime screens and the Bindings editor. Moreover, there are two ways of implementing component painters. In a first way, the editors are configured per field and stored. The editing screen is assembled by combining individual editors. In a second way, the editors for all the field, along with layout definitions and validation rules are stored together as an XML file and then at render time, the layout definitions in the XML file are loaded and rendered. In an embodiment, the business rules application 112 uses asynchronous processing for many operations. In an embodiment of the present disclosure, the business rules application 112 uses the asynchronous processing for running user operations in their own thread and not blocking UI thread. For example, when a user X clicks a button to run a workflow, the UI thread returns immediately while the workflow operation is run in its own thread, thus making the UI thread more responsive. Further, the business rules application 112 uses a server push technology to get around problem of updating the UI threads from Non-UI threads. When the asynchronous operation completes and the results must be updated to the user. Moreover, the business rules application 112 uses the server-push technology to update front end.

In another embodiment of the present disclosure, the business rules application 112 uses the asynchronous processing for recording the user usage data and monitoring statistics. Moreover, the business rules application 112 uses one or more asynchronous libraries to enable the asynchronous processing. The one or more asynchronous libraries include eclipse core runtime, rabbit mq messaging, quartz scheduler, cloud connectivity and the like. The business rules application 112 fires the usage and other data asynchronously to a rabbitmq queue and a scheduler job picks the usage and other data and processes it. Consumed units and net units available for the user is returned back to the business rules application 112 and displayed to the user. This works across vms and servers as the rabbit mq is another process in itself. Further, the scheduler can run as a service in the business rules application 112 or by itself.

In addition, the business rules application 112 uses a query paradigm for running the plurality of business rules 206. The user submits a query for which a result is returned. The result can be single or multi valued. The rule composer 208 of the business rules application 112 provides a result layout editor for configuring a layout for the result screen similar to the beans layout editor for java beans. The result layout editor allows the user to assign a tabbed layout for the result pane with different query results displayed in different tabs with each query result being displayed in a component of its own or along with the results of other queries into the multi valued component. In an embodiment, while displaying multiple values, the user optionally decides whether to have an aggregate function to be run on the results. The aggregate function includes SUM, AVG, COUNT, MIN, MAX and the like. The configured layouts are stored in the database 202 and retrieved at runtime and displayed to the user.

Further, the business rules application 112 provides a base set of features that can be extended via addons. In general, there are over 80 different addons and many are in planning stages. However, the addons exist for web services, per user context, per user VM, sqladdon, nosqladdon, chat messaging addon, runtime webapplications addon, hotdeploy addon, user defined types addon and the like. In addition, the business rules application 112 provides a runtime webapplication addon. The runtime web application addon allows the user to package and deploy their rules projects as an independent web application to be deployed onto a cloud server or virtual machine.

In an embodiment of the present disclosure, the business rules application 112 includes two parts. A first part is the main business rules application 112 and a second part is the business rules runtime application. The business rules application 112 requires a file system to run and the business rules runtime application does not require the file system to run. Consequently, the business rules application 112 runs only on any IaaS or Infrastructure as a service cloud platform and the business rules runtime application runs on Platform as a Service type of cloud systems including CloudFoundry, Heroku and the like.

In an embodiment of the present disclosure, the business rules application 112 deployment is a web scale deployment which is deployed onto a single large server or other servers. The business rules application 112 platform components include web servers, web application servers, messaging servers, caching servers (both in-memory and persistent), database servers (sql and nosql), a storage area network or shared file server, a monitoring/supervisor server, a provisioning repository including nexus maven/osgi/obr/p2 bundle repository, a build and continuous integration server and the like.

Further, the business rules application 112 is capable of using a relational and a nosqldatastore. In an embodiment of the present disclosure, the business rules application 112 runs by using any nosqldatastore including MongoDB, Apache HBase, Cassandra and the like. In another embodiment of the present disclosure, the business rules application 112 uses a combination of sql and nosql. For example, the business rules application 112 uses sql for application data and nosql for usage and other data.

Furthermore, the business rules application 112 uses general settings screen to accept various settings from the user and stores the settings as user profile settings similar to windows desktops. Moreover, the user can set various items including screen width, height, window width, height, logo width height, dashboard width, height, themes, locale and the like for later use. In addition, same settings can be used every time the user logs in to the business rules application 112.

In an embodiment of the present disclosure, the business rules application 112 is multilingual and can run in many different locales by simply selecting the locale using a dropdown in taskbar of a main window. In an embodiment of the present disclosure, the business rules application 112 is social and provides various social features. The business rules application 112 displays one or more social media buttons in the task bar of the main window itself using which the user can lets their social contacts know about the business rules application 112 right from inside the business rules application 112. In an embodiment of the present disclosure, the business rules application 112 provides a tag cloud component and tags feature in rules settings using which they can add meaningful tags to their rules.

Further, the business rules application 112 software is written in java and uses Spring framework, Hibernate, JPA and other related software. Furthermore, the business rules application 112 is organized. The business rules application 112 code is decomposed into a set of modules based on their functionality. Generally, in other business rules software, only a web module, a ui or view module and a data module is available. However, the business rules application 112 is divided based on application level functionality. For example, different modules which are available include a usage metering module, a JMX monitoring module, a persistence module, an xsl transformer module, a runtime module, a asynchronous module, a startup module and the like. These modules expose their functionality as a set of services, thereby making the business rules application 112 an example of SOA or service oriented architecture.

In an embodiment, the business rules application 112 uses one or more Spring service annotations, however it can use any service framework with services being deployed in the same server or different servers even in another location/subnet. Remote communication is handled by a RPC framework with the business rules application 112 providing other components including service registry, web sessions for stateful communication and the like. Some of the components run on devices like watches, cards and the like, and the business rules application 112 manages the command and control.

In an embodiment, the business rules application 112 includes a filestore directory. The user sets the filestore directory by using the general settings screen. The filestore directory loads classes and other artifacts. The Artifacts include rule files, java bean xml files, bean layout component xml files, logo images, resource files and the like. The business rules application 112 at runtime generates Java classes from rules files. These Java classes are stored under the filesystem directory. Generally, in other web applications, the files are stored only under web context root. However, the business rules application 112 lets the user to specify an arbitrary location anywhere on the filesystem as filestore directory. Further, the business rules application 112 uses a filesystemclassloader to load files and artifacts stored under the filestore directory. The filestore directory uses a folder structure to organize files, java classes, images and other files for the plurality of users. The folder structure is as follows:

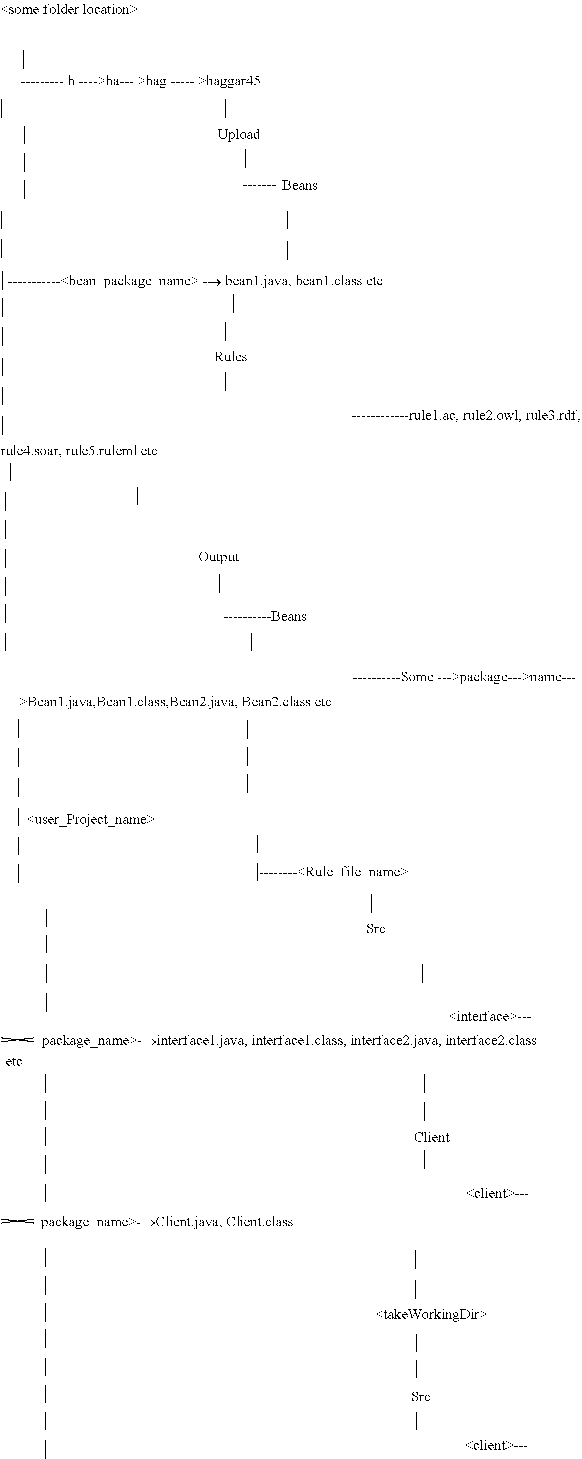

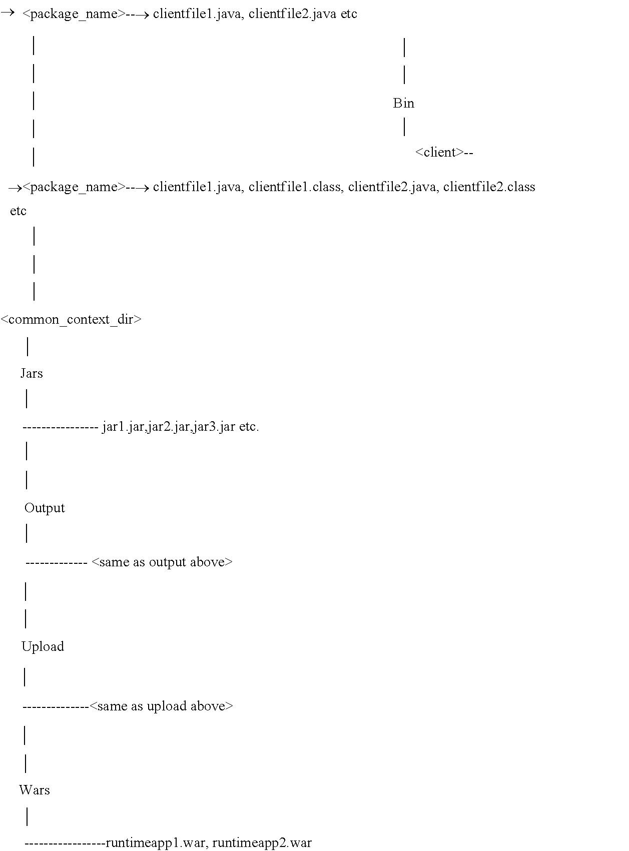

The business rules application 112 defines a common context directory <common_context_dir>. The common context directory (hereinafter ‘CCD’) stores the sample projects and their content. The contents of the CCD are common to every user. When the user selects import sample projects from the general settings screen, contents of the sample_projects folder is copied under the user filestore directory. Further, the CCD stores common jars needed by the business rules application 112 at runtime on the compilation class path. In an embodiment, the business rules application 112 defines two class paths. The first is a runtime class path and the second is a compilation class path.

In an embodiment of the present disclosure, the business rules application 112 transforms rules files into Java files and then compiles the Java files into java byte code class files. In another embodiment of the present disclosure, the business rules application 112 transforms rules files into Java bean files and then compiles the Java bean files into java byte code class files. These files are added to an application after the business rules application 112 has been started and not available on the runtime class path. The business rules application 112 uses the filesystemclassloader to add them to the runtime class path. Further, for compiling rules files and rules client file, some jars are needed on the compile time class path which is provided by the CCD jars directory. Moreover, warfiles from the runtime web application addon where user projects are packaged as web archives or wars are stored under CCD/wars. Likewise, any number of folders having any name can be added to the filestore directory for various purposes.

In an embodiment, the business rules application 112 running on the communication device 104 doubles as Cloud Client (hereinafter ‘CC’). The CC at startup connects to the running application on the web, assuming a REST web service is running and the user has purchased the REST addon. Further, the CC downloads the user's project and rule files and their settings. The user then can run the workflow on the rules locally and run the rules. Any changes made, the rules or projects can then be updated to the business rules application 112 web project right from inside the CC using the WebDAV or WebFTP server and added to the JSR 283 repository. Thus, the business rules application 112 manages the user's server projects as well as client projects.

In an embodiment, the business rules application 112 running on the communication device 104 provides its own component painter implementation for java beans which is different from web version of the business rules application 112. In this, the user first generates form config xml files for each java bean. Then, when the java bean is to be rendered, the business rules application 112 uses the SwingBeanFormBuilder component to dynamically render the screen from the XML on to the screen. The SwingBeanFormBuilder takes care of loading the bean form from a java bean object and storing the values to the java bean object after updation by the user.

In an embodiment, a mobile version of the business rules application 112 runs specifically on mobile communication devices, for example, on mobile phones, tablet/IPADs and the like. The mobile version of the business rules application 112 uses a Mobile SDK user interface toolkit to draw the screens and runs in local mode and remote mode. The local mode stores data to phone memory and the remote mode communicates with the running server via a REST API. In addition, the mobile version of the business rules application 112 uses mobile friendly gestures including slide and swipe instead of tabs, buttons and the like to render the business rules application 112 on the mobile screens, tablets and the like.

In an embodiment, the business rules application 112 running on the communication device 104 is a full fledged OSGi application that is fully modular and built as per OSGi standards. The business rules application 112 running on the communication device 104 updates automatically without having to uninstall and reinstall the software. New features can be added and old features can be removed as snapins by using the OSGi plugin architecture. An added benefit of the OSGi is that it dynamically refreshes changed rules from java byte code without closing and restarting the communication device 104. Further, the business rules application 112 running on the communication device 104 is a state-of-art java desktop application with features including java swing, for example, Menu, toolbars, MDI Tabbed desktop, project explorer, multiple document views, docking layout, syntax highlighting, content assist and the like. Furthermore, the business rules application 112 running on the communication device 104 is almost on par with existing RCP platforms like the eclipse RCP and netbeans RCP.

In an embodiment, the business rules application 112 provides a plurality of runtime views for running rules. The plurality of runtime views includes dynamic runtime view and a wizard runtime view. The business rules application 112 provides an innovative runtime view called a wizard view that follows a querying paradigm where the user submits a query and the business rules application 112 provides results. A Wizard in UI systems is a mechanism that displays the user a series of panels for entering values. When the user enters an input in a final panel and submits the panel, entire data from all the panels is submitted for processing. The business rules application 112 leverages the wizard pattern to display a wizard to the user and the user first selects a query to run. Number of panels and their contents corresponds to number of parameters to a query and their corresponding types. When the final panel is submitted, the business rules application 112 runs the query and displays the result to the user. By using the wizard view, the user can run the plurality of business rules 206 query one at a time.

In addition, the business rules application 112 provides a dynamic view for running rules and viewing results. In the wizard view, the user can run only a single query at a time. However, in the dynamic view, the user can run all the queries in their rules project and view the results. For this purpose, the dynamic view provides a split layout with the top pane for user input and a bottom pane for viewing results. The top pane is called the bean pane and the bottom pane the result pane. The bean pane has a tabbed layout with each tab displaying a bean. Number of tabs is equal to number of distinct beans in a business rules project. A tab displays a java bean and any other data which the user enters, gets stored in the corresponding bean object. The bean pane is dynamic and has event listeners attached to every component on the screen. For every action initiated by the user including a tab out, checkbox select/deselect and the like, an event is fired, the data from the panels is retrieved and set in the java bean objects. The business rules application 112 then runs all the queries and displays the results to the user. For displaying results, the business rules application 112 renders the result pane layout configured by the user using the result pane layout editor and populates them with the results. As an example, if the user does not wish the queries to execute for every tab out, then he may set the configuration parameter run RulesOnTabOut to false. In that case, the business rules application 112 displays a ‘run’ button, and the user explicitly clicks ‘run’ to run the rules.

Further, the business rules application 112 with a GWT addon, uses a web framework based on GWT for its front end. The GWT is a web framework that lets you work in java and then compiles the entire client code into a single large javascript file that runs on the user's browser. The Javascript does not provide reflection capability which is the ability to inspect a java class and report its methods and attributes. The business rules application 112 has a need for reflection on client side for layout editor which needs to inspect a javabean for its attributes and their types. The javabean may have been created by the user by using the Bean Generator. When the business rules application 112 runs using GWT, the GWT cannot know of the bean's existence and therefore cannot inspect the bean class. To circumvent, many methods are available in GWT but none of them are very useful. However, to circumvent, the business rules application 112 makes a RPC call to the server with bean name as parameter. The server side GWT loads the bean by its name using the filesystemclassloader. The server side GWT returns the beans attributes along with their types in JSON format back to the client. The GWT client parses the JSON and populates the list. The GWT RPC requires a servlet to be defined for the RPC call which the business rules application 112 defines in web.xml.

In an embodiment, the business rules application 112 layout editor only supports 1-column, 2-column and 3-column layouts for JavaBeans. For other layouts, the business rules application 112 has developed custom layout scheme for JavaBeans. In an embodiment, the user uses the GWT designer to design their javabean layout and then upload the generated component.xml to the business rules application 112. The business rules application 112 then uses the component.xml to display and edit the javabean. The user can use other methods to design their java beans including hand coding them. The only requirement is that bean fires property change events whenever the bean field is updated with the bean name, bean field name, its old value, new value and the like. The user uploads the java source file and the business rules application 112 uses the generated class file to display and edit the bean.

In an embodiment, the business rules application 112 has workgroups addon. The workgroups addon is useful for registering as an organization instead of a user. A user may purchase one or more plans by way of volume discount facility. In an embodiment, the user making a purchase would be an admin user and an email is the admin email. The admin user logins to the business rules application 112 by using their credentials and add the plurality of users as the number of plans they have purchased including the admin user. When these other users login, the business rules application 112 would not make a subscription check via API to see if they are valid subscribers. Instead the business rules application 112 checks the database 202. This way each user gets own usage units. In an embodiment, more than one user can login using the admin user's credentials. In this case, the admin user's usage units would be divided among those using the admin user account.

Thus, the BRMS is based on usage units and subscription plans. Each subscription plan is associated with a fixed number of usage units available to the user. Usage units are needed to use the business rules application 112. For every operation in the business rules application 112, usage units are deducted from the user's account. This is referred to as usage metering. The usage units vary according to plan and usually start at 1000-2000 units for the base level plan and extend to unlimited usage units for the premium plans. Each operation has a certain number of usage units assigned to it and when the user performs that operation, the number of units is deducted. For some operations, when the operation is reversed, the units are credited back to the user account.

In an embodiment, the business rules application 112 includes a concept of bundles. Like plans, bundles too have units assigned to them. However, bundles are categorized functionally as ‘bundles of 10 java beans’, ‘bundles of 20 bindings’ and the like. If number of usage units per java bean is 10, then a bundle of 10 java beans would result in a total of 100 units being assigned to the user's account. Alternately, the user may also buy bundles of units directly as a bundle of 5000 units or a bundle of 10000 units.

In an embodiment, the business rules application 112 collects statistics of the user's usage of business rules application 112. Thus, all usage is recorded via JMX MBeans. A JConsole tool may then be used to view the usage of the JConsole, however, it can only be run locally to view the JMX data. For remote viewing of JMX data, a software like Hyperic is needed. However, the Hyperic requires the user's ip address to connect and load the data. For this purpose, the business rules application 112 at startup, records the ip address of the user to a server via REST API. Further, the business rules application 112 records the ip address of each of the plurality of users. The ip address thus recorded can be used for other purposes including sending push notifications to the user or to enable group chat among the plurality of users. Further, it is possible to plot the user's client work state on ip and the server ip on to a map on a large screen to get a bird's eye view of an identity and location of the user.

In an embodiment, the plurality of users can visit My Account section in the business rules application 112 to view their details. Each of the plurality of users can view/edit their registration details, subscription plan details, usage details and the promotions that are being run. The user may also suspend or cancel their account. Suspended accounts remain inactive until activated again by the user. Once canceled, whether the account remains active or not depends on a type of subscription purchased by the user. If the user has signed up for a plan that requires a contract, the user's account will be canceled and no prorated refund will be made. Moreover, if a merhcant's refund policy allows it, a partial refund may be made based on number of days remaining in the plan. As an example, if the user is subscribed to the ‘Month-to-Month’ plan, the user can cancel any time. The account will remain active until end of the billing cycle or month. The account will only be activated if the user renews their subscription.

When a user logs in, the user is displayed a summary information of their activity, including statistics and graphs of information as their usage units remaining, time spent and the like. From here, the user navigates to a main dashboard. The main dashboard is where the user selects what they wish to do next. The user can select from many tabs, for example, Manage Projects, Manage Beans, Manage Rules and the like. The main dashboard presently uses an Accordion layout. The accordion is a component that displays tabs that can be expanded or collapsed. Each tab is titled with a section header including Projects, Rules, Beans and the like. Each tab when expanded, reveals more tabs for operations for that section, for example, Add Projects, Add Rules and the like. The user makes a selection and the corresponding screen is loaded on to the right side of the window called a canvas. The dashboard also has a header and a footer. The header has a logo on top left and displays a banner at top right. The footer displays a copyright message, social media buttons, and the task bar with buttons to visit ‘My Account’, change locale, change theme and the like.

Another type of layout for the dashboard is a Portal layout. A main window of this layout contains many smaller panes for displaying data to the user and each pane has a title and icons to expand/collapse the pane. Yet another layout is the Metro layout. A main window of this layout displays boxes similar to boxes in Windows 8 and above. In an embodiment, more layouts for the dashboard may be added in future along with more themes.

Further, the business rules application 112 is an XML editor. The business rules application 112 provides a grid view for editing tabular XML data. The grid view is implemented on top of the JXTreeTable from swingx project which is part of the JDesktop project at Oracle Sun Corp. The JXTreetable itself is based on the JTreeTable class. The XML grid view treetable is referred to as JXmlTreeTable and extends the JXTreeTable for editing and viewing XML. The JXTreeTable displays hierarchical data and easily displays XML. However, attributes of XML elements can only be displayed as child nodes of element nodes. When XML is viewed as text, attributes are not child nodes of element nodes and sit alongside like so <person name=“bob”/>.

The JXmlTreeTable eliminates this difference making attributes display next to element nodes. The JXmlTreeTable works by implementing a custom enumerator of treetable nodes and then plugging this into a TreeTableapi. In addition, the JXmlTreetable traverses a TreeTable data model and builds a map. A getValueAt and getTreeCellRenderer methods of the JXTreeTable are overridden to display correct data for that table cell and also use a custom renderer to display data besides other changes. The JXmlTreeTable is convenient for editing tabular XML data and allows editing of nodes, attributes, content and the like in place inside the grid itself. Attribute and content nodes are edited easily using the DOM API itself. However, in the DOM 2.0 API, nodes cannot be renamed without destroying the current DOM and replacing it with a new DOM. The DOM 3.0 provides the rename Node. The JXmlTreetable provides the node rename facility in place without notifying the user that the XML DOM has changed using the JAXP, XML and XSL transformation API. Further, content nodes can be edited in a text box that pops up when the node is clicked. The JXmlTreeTable is suitable for performing XPath/String/RegEx searches on nodes and highlighting matching rows.

The JXmlTreeTable grid view works in tandem with the text view, so changes made in the grid view are updated in the text editor in real time and vice versa. In an embodiment of the present disclosure, it does this by using a plurality of XML models including the AXI, XDM and XAM models instead of the usual XML DOM model. Changes made in the text editor are incrementally updated in the grid view XML models without parsing XML data which would destroy current XML data model and affect display of the treetable grid. Instead incremental changes and updated on to the XML AXI, XDM and XAM models to maintain a ‘cliff’ of the XML structure so node identifiers are retained. In another embodiment of the present disclosure, the JXmlTreeTable does this updation inside of the context of a transaction so a batch of changes can be reverted by the user if they wish to undo their edits.

In an embodiment, the business rules application 112 runs well in an appengine platform. However, only runtime applications from the java version of the business rules application 112 can run in the appengine platform. The business rules application 112 requires a filesystem to store files which is not available in the appengine. However, the business rules application 112 runs well using the Google datastore. The business rules application 112 uses a datastore API to load and store entities.

In an embodiment, the plurality of business rules 206 expose its services via easy to use the REST API and the XML API. In an embodiment of the present disclosure, the user can connect to the business rules application 112 from other programs written in any language using the API. In another embodiment of the present disclosure, the user can use the plurality of business rules 206 as a service from cloudfoundry, Heroku, Microsoft Azure cloud and other places as addons. The API calls will have to be signed and secure via oAuth and oAuth and present when making the API call. Similarly, the user should have a valid subscription or have purchased the addon and have sufficient usage units available in their account to use the business rules application 112.

The runtime projects of the business rules application 112 can be deployed as web applications by using a runtime webappaddon. The runtime web applications can run in a same server, a data center, or can be deployed to other servers, a bare-metal server, a cloud VMs, a platform-as-a-service PAAS systems and the like. In an embodiment, the runtime web applications are designed to run on PaaS systems like CloudFoundry and Heroku. The business rules application 112 usage metering can be turned off and replaced with a one-time per project fee when deploying to the PaaS systems. Optionally, a single-sign-on facility may be provided to the user to be able to use the business rules application 112 as well as the business rules runtime application using the same credentials. A Snaps addon is available where the user's runtime web applications can be launched via links from a host web application which provides dock/undock facility for the user's runtime web application as well as a central place to manage the runtime applications. The business rules application 112 uses Maven builds and Git based version control system to enable deploying to the PaaS systems. The business rules application 112 runs a build server on internet running a Nexus repository for retrieving build artifacts from the web.

Further, the business rules application 112 has a lite version. The lite version is a light weight version that runs using the smaller instances or the base tier instances usually provided by cloud vendors that have maybe 500 MB-2 GB of RAM and 8 GB of disk space and maybe 1 or 2 cores. The lite version replaces the relational database with an in-memory database including MySQ1 embedded, HSQL, H2 database and the like. Further, RabbitMQ messaging is replaced with a beanstalkd or ActiveMQ implementation.

Furthermore, the business rules application 112 is versatile and can run using any persistence framework or datastore. The business rules application 112 can use Hibernate JPA,Eclipselink JPA and Spring Data. The business rules application 112 uses RDBMS for data storage and can easily use a NoSQL datastore including MongoDB and Apache HBase. The business rules application 112 provides scripts and tools as addons to convert data between SQL and NoSQL datastores. Further, the business rules application 112 provides ETL tools by itself and also adpaters to popular ETL software like informatica to load/store rules from RuleML, R2ML, RDF, OWL, XML, Excel, Jess, CLIPS, Prolog, OpenRules, BPMN, DMN, BPEL, SRML, N3, Turtle, N4 and the like.

In addition, in the business rules application 112, rules are assigned by RuleFilelds once they are saved. Saved rules and their id and other details can be viewed from Rules Manager. Uploaded rules are saved and assigned ids and can be viewed from rules manager as well. A create_method, a create_user and a create_date field are available to what the user created. The rules can be viewed, edited, deleted or downloaded from rules manager. The rules must be valid to be edited in the advanced rules editor. The rules that are not validated must therefore first be validated before loading in the editor. The validation can be turned off via configuration parameter to load any type of rules in the editor. Existing rule file ids are maintained and do not change when saving. Once rules file is saved, a workflow is reset and must be re-run. The rules status, the rule file id and the project id are displayed in the status bar at the top. The rules status clearly depicts correct status of rules file as newly created and validated, workflow run. The project id and the rules file id are the primary means of identifying the rules project. The rule file must be made active using the rules manager in order to add bindings and run the rules project.

A rules workflow is also fairly sophisticated. Generate Interface, Generate Client and Generate standalone client workflows are available. Active rules file and rules settings must be set to run workflow. The Workflow can be run asynchronously or synchronously. The Workflow screen displays the progress via a progress bar. When run asynchronously, the business rules application 112 uses the server push technology to update the UI, display progress bar, status and the like. The usage is metered for workflow. After workflow is complete, the UI is updated and the workflow status is updated in the database 202. The view status button displays the result of the operation. Operation history is also available.

A GenerateClient is a highly intricate design. Client files can be generated beforehand or the files can be generated on demand when the first query is run. This means that when the first query is run, the client rules class may not exist. A business rules application 112 client was developed precisely for this purpose. The business rules application 112 client checks to see if the client rules class exists. In addition, the business rules application 112 client also allows the user to initialize the bindings, factstores and the like in the rules before running them. Any caching of beans, rules and the like can be done. The business rules application 112 client must be generated per rules project as each rules project may have different rules and queries each having different parameters of various different types. The business rules application 112 client provides wrappers around every rules query and also wraps the result along with the rules that were fired for each query inside a hierarchy of list and maps for easy display on the front end.

The business rules application 112 does not assume any state such as whether it is called from a web application or via API. Further, the business rules application 112 client can be called using RPC as a remote procedure call and thus set the project and rule file id once and invoke the queries. The business rules application 112 client can also be called via REST API in which each call must have project id, rule file id, query names along with parameter lists to run successfully. Rules only accept java bean objects as input. The REST API only allows string format messaged. The business rules application 112 client accepts the name-value pairs sent via the REST API and creates javabean class instance objects from them which it then passes to the rules.

Further, the business rules application 112 supports factstore projects. The factstore projects have rules for which facts must be loaded from the database 202. A factstore implementation class must be provided by the user. A factstore template editor (FTL) allows crafting the template for factstore class using velocity template engine. AGenerate factstore workflow step uses the template to generate the factstore class. The beans already have persistence annotations so they can be bound easily to the resultset returned from the database 202. Similarly, the JPA persistence configuration is available or another can be provided to let the factstore implementation to know which database to connect to. Further, the factstore implementation uses Hibernate JPA so the user does not even need to write queries and use Hibernate ORM to work with objects instead. Using Hibernate JPA, an entire graph of objects can be retrieved and available to the rules, for example, Student→Grades, Employee→Department and Product→parts. The factstore retrives data from the database 202 and returns an iterator of entities. The user provides the implementation for hasNext( ) and next( )methods of the iterator. The FTL makes it easy to provide the implementation. For large resultsets, the data need not be retrieved in a single resultset. The user may provide a paging mechanism in the GUI and the data can be retrieved in batches between a start index and an end index, thus saving on memory. The factstore is not meant only for database 202. Any datastore can be used, for example, NoSql, text file, XML file,objectdatastore or external webservice. The factstore implementation class must manage the transformation to the bean entities. It is a one-time operation and once the class is generated, the query can be run hundreds of thousands of times. This is a valuable feature for large businesses, for example, Warehouses, E-commerce retail vendors, Auto parts and the like.

The business rules application 112 running on the communication device 104 uses XML file for javabeans rendering. The XML file called form config file is generated by a wizard that reads a java bean class file. A package name is added to the xml file. The business rules application 112 running on the communication device 104 does not prompt the user to enter the bean package name. This would entail the user specifying the bean class path as well. Instead, the business rules application 112 uses JavaP to read the package name directly from the bean class itself. The JavaP writes output to stdout and does not return a string. The business rules application 112 uses a JavaPWrapper to write an output of Javap to a String Writer instance and thus return a string format result to the business rules application 112.

The web version of business rules application 112 includes a general settings screen. The general settings screen is where the user sets the filestore directory. Further, the user specifies a few other application level configuration parameters. The user can set ‘AutoGeneratePackageNames’ to true or false. The business rules application 112 uses beans package name scoping in to identify which beans belongs to which user. When using in SaaS mode, number of users is high and to avoid name collisions, the business rules application 112 automatically generates bean package names, for example, com.foo.bar, foo.bar.baz and the like assuming an auto generate package names is set.

Another setting in general settings screen is the Import sample projects. The business rules application 112 provides sample projects that contain examples of fully valid rules files for various project types supported by the business rules application 112. These projects are ‘ready to run’ projects for which all beans are available, rules are validated and workflow has also been run. The layouts have also been set. The user can import sample projects the first time they set the filestore directory and submit the general settings. No action is taken if the sample projects already exist.

The web version of the business rules application 112 is only accessed using a browser. The business rules application 112 dashboard and the main window are optimized for running on a 1290×1068 laptop computer with a 15″ widescreen display. However, the plurality of users using the business rules application 112 may use other display sizes and screen resolutions. The plurality of users can use the general settings screen to adjust the dashboard and window dimensions for their screen size and resolution. The parameters that can be set includes Window width, Window height, Screen Width, Screen height, Dashboard width, Banner height, content height, logo width, logo height and the like. The user can also set these parameters for every screen resolution he has.

Further, the business rules application 112 includes a beans generator. The beans generator is a vital component that allows generating JavaBeans from XML files. The beans generator uses an XSL stylesheet to generate javabeans. The XSL stylesheet uses a combination of entity, URI resolvers to customize and generate the javabean. For example, the user can use aliases for bean field types. For real numbers, the user can enter real instead of double or float though they could enter those as well. The bean generator automatically maps type to a correct java type and generates the javabean. The user can add literal java code inside of bean methods. XML files cannot contain java code in content items and the java code must be placed inside CDATA sections. The business rules application 112 wraps java code in CDATA sections allowing java code to be run from rules.

Moreover, the JavaBeans contain ‘equals’ method. The equals method determines whether two javabean instances are equals. The two instances are equal if the both refer to a same object; however other criteria are also possible. There other criteria may include but not be limited to id fields, name fields, ssn or other type of id fields. The bean generator allows the user to specify which field or fields determine equality and what the test should be. The user may use grouping to create a compound statement that determines if the two beans are equal. The Beans editor GUI provides this functionality. The user can specify multiple beans in the bean xml file in which multiple java beans are generated. Beans appearing later in the XML file can refer to beans appearing before them. A Book bean may contain a field Author which is a javabean defined before the Book bean in the bean.xml file. The Book bean and the Author beans are generated successfully by the business rules application 112.

The business rules application 112 displays a usage meter in the main window status bar.

The usage meter appearance is like a taxi meter and displays the usage units available to the user. Every time the user performs an operation, the usage units for that operation are deducted from the user's account and the net available units are displayed to the user. The usage units include 6-8 LED digits. The usage units of the user are translated to the LED digits before being displayed with leading zeroes. For example, 9999 would be displayed as 0 0 0 9 9 9 9 if length of the usage meter was 7.

Moreover, the business rules application 112 uses aspects to do the usage metering. The business rules application 112 uses a simple aspect implementation that does not use point cuts. The business rules application 112 mimics behavior of aspects by calling ‘checkUnitsAvailable(operation) before the operation is executed and after operation method to deduct units. If units are not available or other exception occurs, the checkUnitsAvailable method throws an exception and the user operation is not called. Instead, an alert is displayed with a reason for failed operation. The aspects correctly determine the number of units needed for the operation for simple as well as complex operations including rules validation. Rules validation requires units to be deducted for each bean, bunding and the like used in the rules as well as each class, method and slot present in the queries. The Rules Aspect runs the validation process to accurately meter the units needed for the rules validation. However, the units are not deducted until the user operation runs at which point the units are deducted only once. Wherever possible units are credited back to the user when the operation is undone. For example, when a project is deleted, the number of units is credited back to the user.

Further, each operation in the business rules application 112 can be metered and most operations are metered. The metered means deducting units from the user's net available units for every operation. The usage metering is not done for users holding premium plans for unlimited usage. The units can be defined for every operation and stored in the database 202. At startup, the business rules application 112 loads the table data and stores a map of each operation name and its usage units required.

Rules upload screen is available in the business rules application 112 to upload files to the server. Many file types are supported including rules files, xmlfiles, images, java source files and the like. The Java class files can optionally be allowed after scanning them for malware. The XML files can be of bean xml files or bean layout definition xml files. Optionally, the xsl transformations can be run on the xml file to generate beans direct from file upload screen itself. Java source files of beans will be compiled to their class files here. Once uploaded the rules file can be validated and stored in the database 202. The rules file is then available for viewing in the Rules Manager. Multi file upload is available where the framework supports it.

The business rules application 112 uses an editable table implementation which is used in many screens. The editable table is different from other client side javascript editable tables. In these types, it runs entirely on the server side. Further, it is composed from primitive layout widgets like Row, Column, Grid and the like to give the appearance of a table. The Editable table is a generics type that the type of data being edited can be parameterized. The same table class can be used to edit any type of data as long as it is a javabean type. During initialization, the editable table is provided with a BindingContext and a list of values. The Bindings context specifies the type of javabean in the list of values. Column names are set via adapters. Property change listener is then registered for table events and handled. The editable table and the Component painter both make use of an EditorProvider interface. The editable table accepts a list of editor providers that describe the editor component to be used to edit a particular cell. The editable table can be used to edit simple types like int, double and user-defined javabean types. The beans layout for the javabean will be used to edit the bean if it exists already.

Bean Binders are central to the component painter and editor providers. The Bean Binder as name implies binds a java bean object to a set of editor providers and to a component painter. The Component painter reads the properties from the java bean, the layout editors from the editor provider and renders the javabean in a layout selected by the user. As java beans can contain other java beans, so too can bean binders. It is the bean binder that is responsible for reading the property value of a field and setting it in its parent thus allowing a chain of bean binders to be created.

For editable tables, column definitions are provided as PropertyAdapter specifying the column name and column type. The binding editor uses an editable table that can edit simple types and user-defined java bean object types. The business rules application 112 uses OGNL for defining property adapters. The OGNL can use reflection to read bean property values. However, in the business rules application 112, a ‘binding value’ may be a simple type that must be stored as text in a table column or a serialized object that must be stored as a clob in another table column, both columns referring to the same binding. The business rules application 112 defines a DualPropertyAdapter that automatically loads/stores a column if the type is a simple type and another column for object types.

The rules editor is also an instance of editable table. Each row contains a rule and has 3 rows. The first row holds the ‘ruleset category’, the second row holds the description and the third row holds the rule id and rules text. However, the binding context for the table specifies only a bean for the entire row. Thus when rendering the rules editor screen, 3 rows are drawn for every row or javabean in the table data. When saving the table, the data must be retrieved from the individual fields and set in the java bean and saved. The components of the screen are added to a list after they are added to the screen. When retrieving the field data, the following algorithm is used:

For each row, get row ordinal. The Row ordinal is 0 for first row category, one for second row or description, two for rule id and three for rules text and set in the bean.

The Pagination is available for the editable table data. When the table is rendered, the data is rendered in pages as per the setting of start index, end index and pagesize. First, last, next, prey navigation buttons are provided for the user to scroll to a place in the rules file that they wish to edit/view.Rule ids are generated automatically in the rules editor. The rule ids can be generated as per a mask set in the rules editor header. A simple format is set for the mask ‘Ccdd ’ where each rule id character can be a character, a digit or the underscore. The length can be set as desired. This method is used for simple rule id strategy. A smart rule id strategy is also available. For example, when using rules chaining, some set of rules may depend on the result of a set of rules defined earlier and share the same predicate. The summary rules may then refer to the above predicates and define another predicate. All the above rules may belong to the same ruleset category. In such cases, the user can use the provided start new ruleset, start new rule subset, start new tier buttons to render ruleids as follows:

AE_PEC_01, AE_PEC_02, AE_PEC_CEF_04, AE_PEC_CEF_05, AE_01, AE_02 and the like. The AE_PEC is the prefix for all the rules and the summary rules use only the AE prefix.

In the Rules Editor, in each row, the first row is the ruleset category. A rule file may have many rules and each rule has a ruleset category and many rules may have the same ruleset category. The text fields for the ruleset category for all the rules, rows share the same model and are autocompletetextfields. Thus, when the user enters the ruleset category, it is added to a CategoryRadixTreeModel. The Auto complete available in the ruleset category textfield, looks up the CategoryRadixTreeModel for a prefix matching of the first few characters typed by the user. If a match is found, it is added to a list and the list is added to a prompt which is then displayed to the user for auto completion of the ruleset category.

The rules text contains tokens of the format slotname.fieldname or slotname.methodname where slotname is a javabean object type. For example, when the user types customer.name, the token customer refers to the customer slot of the corresponding query which maybe of type com.foo.Customer. This information is used to provide a content assist popup to the user. As soon as the user types ‘customer’, the business rules application 112 checks the slot type, find out it is of type com.foo.Customer and checks the cache to see if the fields for the Customer bean are in the cache. If not, it inspects the customer bean to retrieve the fields, store them in the cache, populate a list and display a popup with the available options for the user.

Further, the business rules application 112 includes two parts, main application and runtime. The main application provides facility to add, modify, delete and view the following items. The items include Global settings, beans, projects, rules, rules settings, bean layouts, bindings, binding layouts, and result layouts and users. Each of these operations is bound to an access control list in a fine grained manner so only users having access as per the declarative security framework used by the business rules application 112 can perform the operation. Further, facility is available for a user to make the changes and another to authorize the change to ensure changes are reviewed before being made final. Further, the dashboard is a fully responsive, Ajax accordion widget where user can quickly navigate from a screen to another. In that case, the user may have unsaved changes in the first screen. The business rules application 112 keeps track of any changes the user has made and alerts the user to confirm if they really want to discard the changes or save them before navigating to another screen. Furthermore, the dashboard uses a transition pane to display the screens. When the user changes from a screen to another, a transition effect such as fade in, fade out, blinds and the like is first played before the screen changes.

The business rules application 112 has a notification area where alerts are displayed to the user from a remote location about updates that the user should be aware about. Clicking on the icon takes the user to a mailbox where they can view all the notifications. In an embodiment, the business rules application 112 has a OpenFireaddon which implements a Jabber XMPP chat addon where the plurality of users can group chat with each other. The business rules application 112 is an OSGi application built on top of aOSGi container, for example, Felix, Equinox and the like and also runs on the OSGi enabled ergo tomcat server. Virgo buildpack is available for PaaS systems like Heroku, CloudFoundry and the like. Moreover, the business rules application 112 also implements a light weight OSGi framework that implements only the service repository part of the OSGi specification. Using this framework, rules projects can be exposed as OSGi services, declarative or otherwise. The business rules application 112 implements the package admin functionality of OSGi that allows dynamic refresh of modified packages and classes.

The business rules application 112 workflow has a ‘Manage Deployment’ screen where the user can deploy their rules projects as runtime web app war files, individual bundles including interface bundle, client bundle, client files bundle, java beans bundle and the like each of these bundles is a valid OSGI bundle. The OSGi container manages the deployment of the bundles in the OSGi container. Moreover, each bundle has an associated bundle name and version. The user may thus have multiple versions of their rules project running side by side as long as they have a different bundle name and version. The runtime web applications also define a web context path additionally. Further, the business rules application 112 manages an OSGi bundle repository that can be either OBR or P2. The bundles are published to the OSGi bundle repository where they can configure to either dynamically picked up by the OSGi container or manually deployed to the OSGi container. The business rules application 112 has the HotDeployaddon where the plurality of users gets access to a web console from which to manage their OSGi bundle artifacts. There are two versions of this addon. The basic version lets the user submit requests for hot deploy which are then processed from a call center run by the merchant. Such hot deploys are governed by SLAs and typically require from 4-24 hours to be completed. A tier 2 of the addons lets the user hot deploy from a web console right from inside the business rules application 112. The OSGi implements the OSGi subsystems specifications. Each user's bundle artifacts are packaged and deployed into their own region and thus isolated from each other. The user can specify the name of the region to view their artifacts and their status.

In OSGi, the user's bundle artifacts are stored in their own region. Each user may have bundled deployed in many such regions, as the number of users may be high, especially when the business rules application 112 is running in SaaS mode, there has to be a way for managing the various user regions. The business rules application 112 manages this by storing the user and their regions in an in-memory cache that is also persistent. This way, when the business rules application 112 has to be restarted either as part of routine maintenance or as a result of a unexpected event, the various user regions along with the artifacts names in them can be retrieved and deployed to the OSGi container. This would make the business rules application 112 resilient and enable it to be restored to the point it was before it went down.

The business rules application 112 exposes the user rules projects as declarative services and also adds a web endpoint to them by registering a servlet with a Http extender. As the number of users grows and their user projects, the number of such web endpoints will grow exponentially and become difficult to manage. The business rules application 112 has come up with a novel scheme to manage the web endpoints. Each web endpoint is stored as a node in a java filesystem API JSR 383 repository like JackRabbit. The business rules application 112 does not directly add the nodes to the JackRabbit. Instead, the business rules application 112 registers nodes via Apache Sling project at sling.apache.org. As nodes are unique, so will the user endpoints. As a document can be stored under such nodes, the business rules application 112 also doubles as a directory browsing software where many different things such as company and people names and other entities can be added and viewed using the REST API. Further, the business rules application 112 extends this by allowing an application to be registered to apache sling. Hence, the application as well as metadata about the application can be easily made available to the plurality of users using this scheme.

The OSGi also makes available Rules projects as services outside the OSGi platform via an addon. The OSGi services are consumable from inside OSGi by other OSGi services only. Optionally, it can be made available as a web endpoint using the http service. Clients could not call OSGi services via RPC style mechanisms like a simple function call. The business rules application 112 makes use of RPC communication layer to make this style of RPC possible. In addition, the OSGi runs in an OSGi enabled server including Glassfish or Virgo tomcat server. The business rules application 112 has been developed as an OSGi stack from a ground up using Apache Aries components. Various OSGI bundles have been mixed and matched including PAX-web bundle, Felix container, Aries subsystems, JPA bundles, Package admin, Admin console, gogo shell, webservice bundle, JCR bundle, hibernate bundle, Spring DM bundles and the like.

Further, the OSGi provides the user with an option of running a per user container. This way, an OSGi container is started only for the user at a time of login and the plurality of users bundles are deployed only to their own container. This facility is available as an addon. Any rules projects and their services along with their packages are exported via a system bundle. Thus the business rules application 112 supports both forms of OSGi deployment. A first form is the business rules application 112 running inside the OSGi container and a second form is the business rules application 112 embedding theOSGi container.

In an embodiment, the business rules application 112 uses a third-party software to manage hotdeployment. Software like JRebel and LiveRebeletc are available and the business rules application 112 uses these softwares easily to provide hot deployment. Further, the business rules application 112 allows itself to be monitored via agents like New Relic. In addition, the business rules application 112 code is organized as a set of services. Its main web app module loads spring context and exports the beans defined in the context to other modules. The other modules use various Spring paradigms including implementing ApplicationContextAware, Autowired, Value annotations and the like to inject the spring application context and retrieve the beans from it.

In an embodiment, the business rules application 112 provides an addon called per user context. The per user context addon allows the plurality of users to get their own web endpoint from which to access the business rules application 112. This addon is available even in SaaS mode when the business rules application 112 has many users accessesing it. Moreover, this is possible with provisioning. As soon as the user signs up for a plan on the merchant website, a scheduler task that executes periodically transmits the user details to the cloud server where the business rules application 112 runs. The user details are transmitted via FTP to a FTP server that is a part of a network where the business rules application 112 runs. Another cron task retrieves file contents and provisions the user web context as well as database 202 for the user if the user has opted for the per user context addon. Further, main web app module of the business rules application 112 contains an init servlet and loads spring context, contains only a servlet class and no other classes. All other classes are available via other modules and are configured as dependencies via Maven. They are automatically copied to the web app WEB-INF/lib folder or even to the <WEP_APP_SERVER\lib%> folder if server space is to be conserved. Any virtual host entries to be added to tomcat and to Apache web server are also added.

When the user first logs in, subscription details are fetched via web service API from the merchant API gateway or directly from that of the payment processor gateway. If a subscription exists and usage units are available, the user is allowed to login normally. Otherwise, the application is reset to demo mode and the user logged in as demo user with default set of privileges. As the subscription API call is time consuming and may easily overwhelm the user if it occurs frequently, the business rules application 112 caches the user subscription details to a cache that's running locally or distributed. This way the subscription details fetch API happens infrequently greatly enhancing the user experience.

Moreover, the business rules application 112 provides a provisioning method instead of the subscription call. As mentioned above, as soon as the user registers the plan on the merchant website, login credentials are generated and mailed to the user. The user provisioning happens before end of day. The user can then use the login credentials mailed to them to login to the business rules application 112.

In an embodiment, the beans can be added in many ways. The beans can be defined in the spring context in which the beans are loaded and made available to the user. The user may generate or upload them using the business rules application 112. The user may also add beans via FTP or other means directly to the filesystem. In that case, the business rules application 112 must be made aware of such beans. The business rules application 112 has two mechanisms to add the beans. One mechanism is to add beans by name directly using AddBeanScreen. The fully qualified name of the bean with package name is entered one per line and is added to the database 202. Another mechanism is a ClassNamelookup screen to find JavaBean classed that has been loaded by the business rules application 112. The business rules application 112 filters classes and jars and only lists other java classes. An Autolookuptexfield is provided so as soon as the user types first few letters of the package or class, the relevant matches are displayed. The user then selects the JavaBeans from them and adds to the database 202.

In an embodiment, the business rules application 112 provides a List and Map generator that allows the user to generate a class that contains a list and a map respectively. The user provides the list of values for the list and list of name-value pairs for the map using the provided GUI. The business rules application 112 generates a java class that has a getList or getMap methods which returns a statically defined list or map that is ready to use in the rules.

The business rules application 112 uses the filestore directory to store files in the filesystem. In an embodiment, the filestore directory should not exist already, should be of valid format specified by the business rules application 112, for example, 6 letters with 1 digit and the like and should be a valid folder name for the platform the business rules application 112 is running on, for example, Windows, Linux, Unix and the like. The business rules application 112 allows export of the business rules application 112 rules as XML, PDF and excel. The business rules application 112can export as its own XML format or other standard XML format, for example, RuleML, R2ML, RDF, OWL and the like.

Further, the business rules application 112 can load and play animations when the user performs an operation. Animations exist for successful completion, error conditions and other events. In addition, the business rules application 112 displays time and date that updates every minute and can expand to reveal a clock in the main window. The business rules application 112 periodically checks to see if the message queue is running and alerts admin or aborts if it is not running The business rules application 112 provides ‘remember me’ functionality for returning users. Further, the business rules application 112 provides a registration screen to register new users with captcha/recaptcha facility. The business rules application 112 checks via ajax if a user name is available. In addition, the business rules application 112 uses a bootstrap loader that loads country/state/city names at startup and uses the data to populate address fields in the business rules application 112.

The business rules application 112 optionally uploads a user profile details to a cloud datastore for collecting demographic details. The business rules application 112 displays a terms and conditions screen while signing up. Further, the business rules application 112 allows the plurality of users to register as users or as organizations. The organization accounts must define the admin user and add other users to the organization. The organizations must specify a company name, address and logo. The business rules application 112 runtime dynamic views use an event bubble mechanism to generate events. When a user tabs out of a text field or selects/deselects a checkbox, the event is not directly generated by the screen itself but must be bubbled from deep inside a hierarchy of layout components. For example, a textfield change event fired by the textfield is first received by the Editor provider Grid which is the class managing the display of all widgets on the screen. The listener retrieves the text field value and sets it in the corresponding property. This again fires an event which is received by the Editor Provider model which manages the java bean objects. The model then fires an event which is received by the bean binder. The bean binder event is then propagated to the runtime window from where an apply rules method is called and the rules are executed.

The wizard view of the business rules application 112 is a dynamic wizard. The wizard's start panel displays a list of queries to the user and then displays a sequence of panels that is determined by the query the user selects. The panels for all the queries are created beforehand but loaded only on demand. Further, the wizard view uses a unique naming scheme to identify panels. The panels display beans and beans pertain to a method and query and query belongs to a rules file and project. The panels also have a numeric index depending on position, the parameter appears in the query. The panel name is thus of the format <query_name> <bean_name> ordinal.

Further, the business rules application 112 makes available a user's project and rules file and other details, for example, usage as RSS. The dashboard at first hides all tabs except the general settings tab and manage projects tab until the user sets the filestore directory. This is performed to avoid errors that would occur if the user tries to use the business rules application 112 before setting filestore directory. Moreover, the business rules application 112 can load and play videos using HTML5 canvas element or as MPEG4, SWF, MOV and the like. The business rules application 112 displays a hierarchical menu in a front end that has menu items arranged in a hierarchy many levels deep. The menu can be a simple menu, a dropdown menu, a popup menu, top menu, bottom menu, sideways menu, a split menu and the like. The menu can be replaced by a task panel on one side of the screen that is a tree view in itself and collapses and expands sections. The task panel can also slide in and slide out of view to save screen space.

Furthermore, the business rules application 112 displays a background image or hide it on all screens, or can show a random background every time the screen is accessed. The business rules application 112 rotates the banner image at the top or even does away with it. The rules editor has a fullscreen button that toggles fullscreen mode for the rules editor. Startup routine contains many methods but the main method is getProjectsData which retrieves the user's projects, checks if they have rules files, and if there are any rule files, retrieves the rules details such as bindings, rules classes details, rules text and the like and sets them in the session. The session variables are reset using resetSession. Whenever the business rules application 112 makes a change to the database 202 as a result of the user operation, the business rules application 112 calls resetSession followed to getProjectsData to refresh the user details, the Hibernate JPA cache and the like.

When the user logs into the business rules application 112, the business rules application 112 determines if the user is a valid subscriber and also fetches their subscription details as their plan and package details. The business rules application 112 must then load the associated entitlements for the user's plan and package and add them to the user account. Ordinarily this information would be hard coded in the application itself. This makes it difficult to change the plan/package entitlements including usage units, duration and the like. To avoid this, the business rules application 112 stores this information in the cloud and fetches them at the time of the user login. The business rules application 112 downloads the package and plan details, usage parameters that are metered, and their usage units from the cloud via API call. Further, the business rules application 112 at this time retrieves some tokens including ‘Go-No’, a prefix and passphrase. The go-no lets the business rules application 112 know if the business rules application 112 should proceed processing. The prefix can be used to prefix table names, buckets and the like to make them unique and the passphrase can be used to encrypt stuff. Further, the business rules application 112 uses a JSON lib to retrieve the data, parse the JSON into Java objects and store them in a session.

In addition, the package and plan details are fetched from the cloud by the business rules application 112 via the API call. The business rules application 112 has various associated tools and scripts. One is a PHP script that reads a table from the database 202 and uploads it to the cloud in JSON format. The PHP script loads the package/plan table and uploads it to cloud in JSON. Further, the business rules application 112 uses a Dummy data loader to initialize package and plan details from the database 202 when needed for testing and other purposes.

Further, the business rules application 112 can set the user's usage units based on a periodic cycle which is usually a month but can be any period. For example, when using in SaaS mode, the business rules application 112 can set usage units for the user on a daily basis. A batch script that runs at the end of day retrieves the user's usage for the day, deducts the usage from the user's net units available and sets the new net units available back to the user account. For example if the user has 500 units available, and he has used 100 units on a day, the units available for them the next day would be 500-100=400. Further, it is also possible to restore the units available to a predetermined level or even back to 500 if it falls below a certain level. Thus if the user units falls below 250, their units can be reset back to 400 or even 500 the next day.

Furthermore, the business rules application 112 creates and deploys OSGi bundles direct from java. The runtime web application continues to meter usage of the runtime application and update the main business rules application 112. This is possible by using web sessions whence both the main web application and the various runtime web applications update the user's usage and net units available to a web session running on another server instead of their local http sessions. Any session or cache implementation can be used for this, for example, memcached, hazelcast as long as the session id is managed correctly.

Further, the rules text is stored as plain text file and in normalized database 202. The rules file is stored in a RulesMstr table and managed by an annotated rules entity pojo by the Hibernate JPA. The business rules application 112 transforms the simple rules file into a Rules vector. The vector here is the mathematical vector and not the utility class from java. The vector in math is a scalar with additional data. For example, speed is a scalar whereas velocity is a vector. Similarly, the rules entity is comprised of various other entities including RulesBeans, RulesBindings, RulesBody, RulesWorkflow, RulesStatus and the like. Further, the rules entity does not store them inside itself but fetches them on an as needed basis using Hibernate lazy loading techniques. Rules associations extends not just to entities that are part of the rules itself but also pertain to the business rules application 112. For example, Rules Status, Rules Settings, Rules Workflow entities all pertain to Rules to provide details as status of a rules file, its settings and the like. These are also stored as part of rules file. Many associations of the rules entity form include OneToMany and OneToOne.

The business rules application 112 is fully capable of running query based rules and reactive rules. The rules can run in response to a user query. Further, the rules can run in response to a user action that causes rules to execute automatically. For example, adding a fact to working memory. As an example, there may be a rule that states, “Employess who join after Jun. 1, 2014 are assigned to dept X”. Thus when employees are added, the above rules would fire automatically depending on the employee join date. The business rules application 112 provides various methods to add facts to working memory WM. The bindings can be used to define facts in bulk and them to the WM. Further, the business rules application 112 provides ‘Add Fact’ button direct from the runtime screen. Facts can also be added via the ‘Manage Facts’ GUI. The facts can be added as XML files. The facts can also be retrieved from external sources via API calls and added to WM. An inline facts mechanism can be used to add facts as well. The business rules application 112 supports Inline facts and external factstore. The Inline facts store facts as part of the rules file itself. For example, studentGrade(‘George’, A), studentGrade(‘Charles’, A+).

In an embodiment, the binding editor allows pagination of the bindings. Further, the business rules application 112 uses mechanisms to display results of the rules files besides the result layouts. The business rules application 112 can load and display a GUI layout defined in a java or other class or XML file and update them when the rules execute or finish executing. This way the business rules application 112 can present the results of the rules execution graphically. The business rules application 112 can also play animations to depict intermediate stages of rules execution. The business rules application 112 allows the user to specify graphics layout for the result pane either programmatically or declaratively. A 3D window may be defined programmatically or a 2D result pane can be defined by the business rules application 112 or by the user declaratively without coding.

In an embodiment, the business rules application 112 may introduce an agent between the user and the rules engine. The Agent executes the commands on behalf of the rules engine and handles the updation of the UI. Further, the Agent is responsible for updating the rules repository 208 of the revised state once the command is executed. For example, the rules engine may issue the command ‘Move Disk’ in a Towers of Hanoi TOH program and the TOH agent would execute a ‘Move Disk’ command and update a revised disk and peg state to the business rules application 112. This would cause more rules to fire until the result is achieved or no more rules can fire. Further, the agent can be a simple program or a complex system including programs, robots, sensors, relays, motors, video camera, image recognition software and the like. The commands would be executed by Robot agents and the revised state fed back to the business rules application 112. In an embodiment, a video or digital camera can capture a scene, run image processing algorithms to automatically detect a revised state.

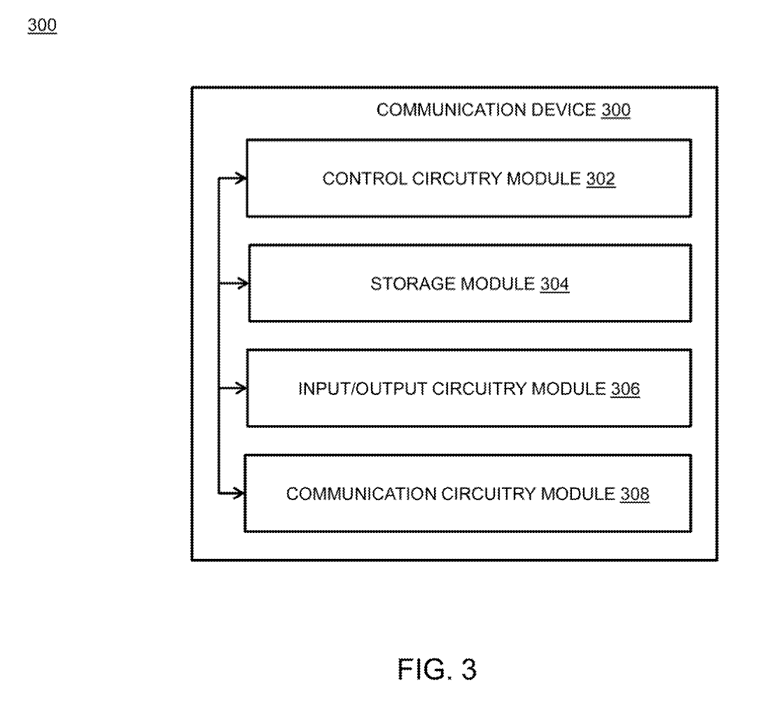

FIG. 3 illustrates a block diagram of a communication device 300, in accordance with various embodiments of the present disclosure. The communication device 300 includes a control circuitry module 302, a storage module 304, an input/output circuitry module 306, and a communication circuitry module 308. The communication device 300 includes any suitable type of portable electronic device. Examples of the communication device 300 include but may not be limited to a personal e-mail device (e.g., a Blackberry™ made available by Research in Motion of Waterloo, Ontario), a personal data assistant (“PDA”), a cellular telephone, a Smartphone, a handheld gaming device, a digital camera, a laptop computer, and a tablet computer. In another embodiment of the present disclosure, the communication device 300 can be a desktop computer.

From the perspective of this disclosure, the control circuitry module 302 includes any processing circuitry or processor operative to control the operations and performance of the communication device 300. For example, the control circuitry module 302 may be used to run operating system applications, firmware applications, media playback applications, media editing applications, or any other application. In an embodiment, the control circuitry module 302 drives a display and process inputs received from a user interface.

From the perspective of this disclosure, the storage module 304 includes one or more storage mediums including a hard-drive, solid state drive, flash memory, permanent memory such as ROM, any other suitable type of storage component, or any combination thereof. The storage module 304 may store, for example, media data (e.g., music and video files), application data (e.g., for implementing functions on the communication device 300).

From the perspective of this disclosure, the I/O circuitry module 306 may be operative to convert (and encode/decode, if necessary) analog signals and other signals into digital data. In an embodiment, the I/O circuitry module 306 may also convert the digital data into any other type of signal and vice-versa. For example, the I/O circuitry module 306 may receive and convert physical contact inputs (e.g., from a multi-touch screen), physical movements (e.g., from a mouse or sensor), analog audio signals (e.g., from a microphone), or any other input. The digital data may be provided to and received from the control circuitry module 302, the storage module 304, or any other component of the communication device 300.

It may be noted that the I/O circuitry module 306 is illustrated in FIG. 6 as a single component of the communication device 300; however those skilled in the art would appreciate that several instances of the I/O circuitry module 306 may be included in the communication device 300.

The communication device 300 may include any suitable interface or component for allowing a user to provide inputs to the I/O circuitry module 306. The communication device 300 may include any suitable input mechanism. Examples of the input mechanism include but may not be limited to a button, keypad, dial, a click wheel, and a touch screen. In an embodiment, the communication device 300 may include a capacitive sensing mechanism, or a multi-touch capacitive sensing mechanism.

In an embodiment, the communication device 300 may include specialized output circuitry associated with output devices such as, for example, one or more audio outputs. The audio output may include one or more speakers built into the communication device 300, or an audio component that may be remotely coupled to the communication device 300.

The one or more speakers can be mono speakers, stereo speakers, or a combination of both. The audio component can be a headset, headphones or ear buds that may be coupled to the communication device 300 with a wire or wirelessly.

In an embodiment, the I/O circuitry module 306 may include display circuitry for providing a display visible to the user. For example, the display circuitry may include a screen (e.g., an LCD screen) that is incorporated in the communication device 300.

The display circuitry may include a movable display or a projecting system for providing a display of content on a surface remote from the communication device 300 (e.g., a video projector). The display circuitry may include display driver circuitry, circuitry for driving display drivers or both. The display circuitry may be operative to display content. The display content can include media playback information, application screens for applications implemented on the electronic device, information regarding ongoing communications operations, information regarding incoming communications requests, or device operation screens under the direction of the control circuitry module 302. Alternatively, the display circuitry may be operative to provide instructions to a remote display.

In addition, the communication device 300 includes the communication circuitry module 308. The communication circuitry module 308 may include any suitable communication circuitry operative to connect to a communication network and to transmit communications (e.g., voice or data) from the communication device 300 to other devices within the communications network. The communications circuitry 308 may be operative to interface with the communication network using any suitable communication protocol. Examples of the communication protocol include but may not be limited to Wi-Fi, Bluetooth RTM, radio frequency systems, infrared, LTE, GSM, GSM plus EDGE, CDMA, and quadband.

In an embodiment, the communications circuitry module 308 may be operative to create a communications network using any suitable communications protocol. For example, the communication circuitry module 308 may create a short-range communication network using a short-range communications protocol to connect to other devices. For example, the communication circuitry module 308 may be operative to create a local communication network using the Bluetooth, RTM protocol to couple the communication device 300 with a Bluetooth, RTM headset.

It may be noted that the computing device is shown to have only one communication operation; however, those skilled in the art would appreciate that the communication device 300 may include one more instances of the communication circuitry module 308 for simultaneously performing several communication operations using different communication networks. For example, the communication device 300 may include a first instance of the communication circuitry module 308 for communicating over a cellular network, and a second instance of the communication circuitry module 308 for communicating over Wi-Fi or using Bluetooth RTM.

In an embodiment, the same instance of the communications circuitry module 308 may be operative to provide for communications over several communication networks. In an embodiment, the communication device 300 may be coupled a host device for data transfers, synching the communication device 300, software or firmware updates, providing performance information to a remote source (e.g., providing riding characteristics to a remote server) or performing any other suitable operation that may require the communication device 300 to be coupled to a host device. Several computing devices may be coupled to a single host device using the host device as a server. Alternatively or additionally, the communication device 300 may be coupled to the several host devices (e.g., for each of the plurality of the host devices to serve as a backup for data stored in the communication device 300).

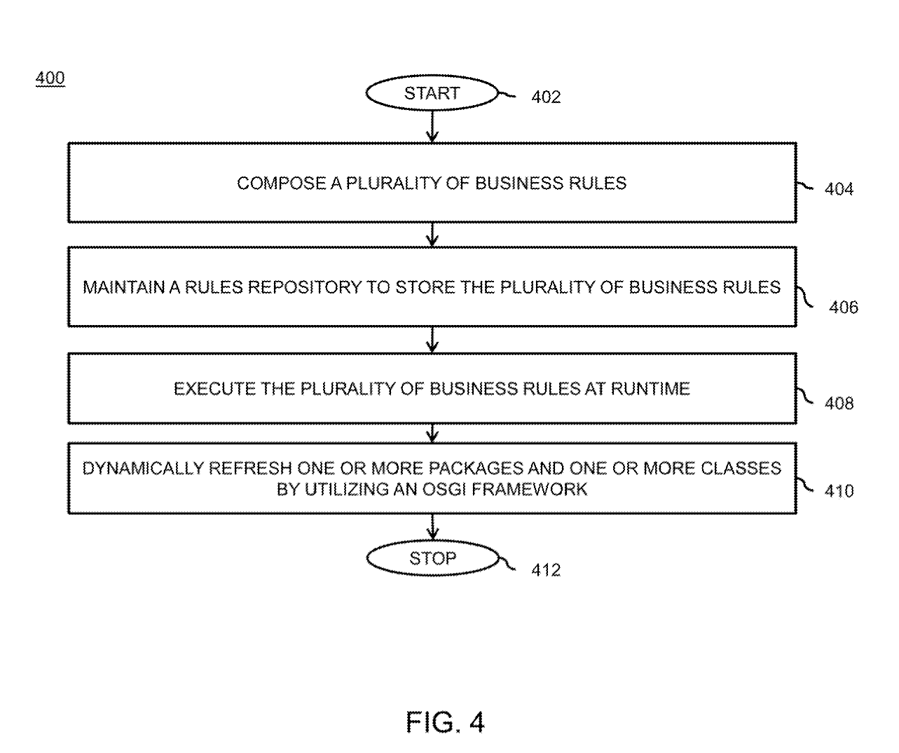

FIG. 4 is a flowchart 400 for composing the plurality of business rules, in accordance with various embodiments of the present disclosure. It may be noted that to explain various process steps of FIG. 4, references will be made to the system elements of FIG. 1 and FIG. 2. The flowchart 400 initiates at step 402. Following step 402, at step 404, the business rule application 112 composes the plurality of business rules. The plurality of business rules implements a plurality of business rules functions. At step 406, the business rule application 112 maintains the rules repository 204 to store the plurality of business rules. The rules repository 204 is updated dynamically with a change in the plurality of business rules. At step 408, the business rule application 112 executes the plurality of business rules at runtime. The execution is performed after dynamically compiling the plurality of business rules in java to java classes having a byte code. At step 410, the business rule application 112 dynamically refreshes the one or more packages and the one or more classes by utilizing the OSGi framework. The OSGi framework dynamically refreshes changed rules from a java bytecode. The flowchart 400 terminates at step 412.

It may be noted that the flowchart 400 is explained to have above stated process steps; however, those skilled in the art would appreciate that the flowchart 400 may have more/less number of process steps which may enable all the above stated embodiments of the present disclosure.

In yet another aspect of the present disclosure, the business rules application 112 is a cognitive agent business rules system. The cognitive agent business rules system includes an application module, a generation module, an execution module and an updation module. The application module applies a plurality of operations to an initialized state. The state is a top level object. The generation module creates a state graph. The state graph is created by adding a plurality of nodes and a plurality of attributes to a top level state. The execution module executes a plurality of business rules based on the adding of the plurality of nodes and the plurality of attributes to the top level state. The updation module updates the state graph. The state graph is updated to reflect a new state of the state graph.

While the disclosure has been presented with respect to certain specific embodiments, it will be appreciated that many modifications and changes may be made by those skilled in the art without departing from the spirit and scope of the disclosure. It is intended, therefore, by the appended claims to cover all such modifications and changes as fall within the true spirit and scope of the disclosure.

What is claimed is:

1. A computer-implemented method comprising:
composing, with a processor, a plurality of business rules, wherein the plurality of business rules being configured to run on at least one of a communication device, a cloud platform and a data centre, wherein the plurality of business rules implements a plurality of business rules functions, wherein the plurality of business rules being run on the cloud platform by using a subscription business model, and wherein the plurality of business rules running on the cloud platform fetches data from the cloud based platform;
maintaining, with the processor, a rules repository to store the plurality of business rules, wherein the rules repository being updated dynamically with a change in the plurality of business rules;
executing, with the processor, the plurality of business rules at runtime, wherein the executing being performed after dynamically compiling the plurality of business rules in java to java classes having a byte code;
dynamically refreshing, with the processor, one or more packages and one or more classes by utilizing an OSGi framework, and wherein the OSGi framework dynamically refreshes changed rules from a java byte code; and
storing, with the processor, the plurality of business rules as a rules vector.

2. The computer-implemented method as recited in claim 1, further comprising providing, with the processor, the plurality of business rules to a plurality of users.

3. The computer-implemented method as recited in claim 1, further comprising metering, with the processor, usage of the plurality of business rules by a plurality of users, wherein the usage of the plurality of business rules by a plurality of users being based on a plurality of usage points available to each of the plurality of users, and wherein charging, an amount from the plurality of users based on the usage of the plurality of business rules by the plurality of users.

4. The computer-implemented method as recited in claim 1, further comprising configuring and adding a bean and providing a grid view for editing tabular xml data.

5. The computer-implemented method as recited in claim 1, further comprising accepting, with the processor, input in one or more formats, wherein the one or more formats comprises at least one of a java bean, a name-value pair, an XML format, a triplet, an OWL/RDF ontologies and objects via bindings.

6. The computer-implemented method as recited in claim 1, further comprising utilizing, with the processor, asynchronously processing to record a usage of the plurality of business rules by each of a plurality of users.

7. The computer-implemented method as recited in claim 1, further comprising storing the plurality of business rules by each of a plurality of users as a rules vector.

8. The computer-implemented method as recited in claim 1, further comprising providing, with the processor, a dynamic runtime view and a wizard runtime view for running the plurality of business rules, wherein the dynamic runtime view generates one or more events by utilizing an event bubble mechanism.

9. A computer program product comprising a non-transitory computer readable medium storing a computer readable program, wherein the computer readable program when executed on a computer causes the computer to perform steps comprising:
composing a plurality of business rules, wherein the plurality of business rules being configured to run on at least one of a communication device, a cloud platform and a data centre, wherein the plurality of business rules implements a plurality of business rules functions, wherein the plurality of business rules being run on the cloud platform by using a subscription business model, and wherein the plurality of business rules running on the cloud platform fetches data from the cloud based platform;
maintaining a rules repository to store the plurality of business rules, wherein the rules repository being updated dynamically with a change in the plurality of business rules;
executing the plurality of business rules at runtime, wherein the executing being performed after dynamically compiling the plurality of business rules in java to java classes having a byte code;
dynamically refreshing one or more packages and one or more classes by utilizing an OSGi framework, and wherein the OSGi framework dynamically refreshes changed rules from a java byte code; and
storing the plurality of business rules as a rules vector.

10. The computer program product as recited in claim 8, wherein the computer readable program when executed on the computer causes the computer to perform a further step of metering a usage of the plurality of business rules by a plurality of users.

11. The computer system as recited in claim 9 wherein the computer readable program when executed on the computer causes the computer to perform a further step of charging an amount from the plurality of users based on the usage of the plurality of business rules by the plurality of users.

12. The computer system as recited in claim 8 wherein the computer readable program when executed on the computer causes the computer to perform a further step of accepting input in one or more formats, wherein the one or more formats comprises at least one of a java bean, a name-value pair, an XML format, a triplet, an OWL/RDF ontologies and objects via bindings.

13. A business rules management system comprising:
a rule composer, in a processor, wherein the rule composer provides a plurality of editors, wherein the plurality of editors comprises an advanced rules editor, a plurality of custom layout editors, a binding editor for simple and UDT bindings, an advanced beans editor, a factstore template editor and a result layout editor; and
a rule manager, in a processor, wherein the rule manager being configured to dynamically compile a plurality of business rules in java to java classes having a byte code by using a java compiler API.

14. The business rules management system as recited in claim 13, wherein the advanced rules editor being configured to allow a plurality of users to perform a plurality of functions, wherein the plurality of functions comprises providing input to add a rule set category, giving description to the plurality of business rules and the plurality of business rules text, and automatically assigning a unique rule id to each of the plurality of business rules.

15. The business rules management system as recited in claim 13, wherein the plurality of custom layout editors being configured for an each bean field type stored in a database.

16. The business rules management system as recited in claim 13, wherein the advanced rules editor being configured to monitor and meter usage.

17. The business rules management system as recited in claim 13, wherein the business rules editor is configured to implement a ComponentPainter.

18. The business rules management system as recited in claim 13, wherein the binding editor being configured to set values for each binding, and wherein the set values being retrieved at runtime during execution of plurality of business rules.

19. The business rules management system as recited in claim 13, wherein the advanced beans editor being configured to allow a plurality of users to use a GUI to configure and add a bean.

20. The business rules management system as recited in claim 13, wherein the factstore template editor being configured to create a template for a factstore class, load the factstore class, set their values and run the plurality of business rules, wherein the factstore class being created by using a GUI factstore template editor, and wherein the factstore class retrieves data from a database and binds the data into annotated java beans.

21. The business rules management system as recited in claim 13, wherein the result layout editor being configured to configure a layout for a result screen, allow a plurality of users to assign a tabbed layout for a result pane with different query results displayed in different tabs.

22. The business rules management system as recited in claim 13, further comprising a database, in a processor, being configured to store a rules repository, beans, a bean field type, values set by the binding editor and configured layout.

23. The business rules management system as recited in claim 13, further comprising a component painter to read properties from java bean, layout editors and renders the java bean in a layout selected by each of a plurality of users.
